(19) United States
(12) Patent Application Publication
(10) Pub. No.: US 2026/0103583 A1
(43) Pub. Date: Apr. 16, 2026

(54) RUBBER COMPOSITION AND PNEUMATIC TIRE

(71) Applicant: Toyo Tire Corporation, Itami-shi (JP)

(72) Inventor: Satoshi Fukunishi, Itami-shi (JP)

(73) Assignee: Toyo Tire Corporation, Itami-shi (JP)

(21) Appl. No.: 19/312,558

(22) Filed: Aug. 28, 2025

(30) Foreign Application Priority Data
Oct. 16, 2024 (JP) 2024-180559

(51) Int. Cl. C08L 9/00; B60C 1/00; C08K 5/103; C08L 7/00

(52) U.S. Cl. CPC C08L 9/00; B60C 1/0016; C08K 5/103; C08L 7/00; C08L 2205/035; C08L 2207/322

(57) ABSTRACT

A rubber composition comprising a diene-based rubber, porous cellulose particles, and a vegetable oil, wherein the vegetable oil is a fatty acid ester triglyceride in which a fatty acid containing at least a saturated fatty acid and an unsaturated fatty acid is ester-bonded to glycerol and has a ratio of the unsaturated fatty acid in the fatty acid of 50 mass % or more. It is preferrable that the vegetable oil has a ratio of a polyunsaturated fatty acid in the unsaturated fatty acid of 15 mass % or more. It is preferrable that the vegetable oil has an iodine value of 100 or more. It is preferrable that a content of the vegetable oil is 5 to 20 parts by mass when a total amount of the diene-based rubber is taken as 100 parts by mass.

### BACKGROUND OF THE INVENTION

### Field of the Invention

The present invention relates to a rubber composition and a pneumatic tire.

### Description of the Related Art

A pneumatic tire is required to have traveling performance in various situations, and in particular, a studless tire is required to improve, for example, on-ice braking performance (grip performance) on a frozen road surface (icy road surface). In addition, in recent years, characteristics required for a studless tire have become increasingly severe in the market, and not only grip performance but also response performance such as steering response performance and running stability performance (anti-wandering performance) on an icy road surface are required to be improved.

Patent Document 1 mentioned below discloses a rubber composition for tires containing 3 to 30 parts by mass of a diene-based rubber which is liquid at normal temperature, and 0.3 to 20 parts by mass of porous cellulose particles which are spherical particles having a porosity of 75 to 95% and a ratio of major axis/minor axis of 1 to 1.5, per 100 parts by mass of a diene-based rubber which is solid at normal temperature.

Patent Document 2 mentioned below discloses a rubber composition for tire treads, including: a raw material rubber containing 20 to 50 parts by weight of a first styrene-butadiene rubber, 20 to 50 parts by weight of a second styrene-butadiene rubber, and 10 to 40 parts by weight of a butadiene rubber (BR); and 80 to 180 parts by weight of a reinforcing filler, 2 to 50 parts by weight of natural oil, and 2 to 30 parts by weight of a hydrocarbon resin with respect to 100 parts by weight of the raw material rubber.

Patent Document 3 mentioned below discloses a rubber composition for tire treads, including: 100 parts by weight of a raw material rubber, 70 to 120 parts by weight of a reinforcing filler, and 10 to 60 parts by weight of a natural oil with a ratio of linoleic acid:oleic acid of 1:0.5 to 1:5, wherein the raw material rubber includes 5 to 10 parts by weight of a natural rubber, 40 to 70 parts by weight of a solution polymerized styrene-butadiene rubber, and 20 to 50 parts by weight of a neodymium butadiene rubber, the solution polymerized styrene-butadiene rubber has a styrene content of 20 to 50 wt %, a vinyl content of 10 to 40 wt %, a Tg of −50 to −20° C., and 20 to 40 parts by weight of SRAE oil, the reinforcing filler includes 65 to 100 parts by weight of silica and 5 to 20 parts by weight of carbon black, and the silica has a nitrogen adsorption value of 160 to 180 m²/g, a CTAB adsorption value of 150 to 170 m²/g, and a DBP oil absorption amount of 180 to 200 cc/100 g.

### PRIOR ART DOCUMENTS

### Patent Documents

Patent Document 1: JP-B2-7357841
Patent Document 2: JP-A-2019-172957
Patent Document 3: JP-B2-6522716

### SUMMARY OF THE INVENTION

As a result of intensive studies by the present inventor, it has been found that it is difficult to solve grip performance and response performance on an icy road surface in a balanced way by the techniques described in Patent Documents 1 to 3.

In light of such circumstances, it is an object of the present invention to provide a rubber composition for use as a raw material of a vulcanized rubber for tires with on-ice braking performance (grip performance) and response performance such as steering response performance and running stability performance (anti-wandering performance) on a frozen road surface (icy road surface) improved in a balanced way, and a pneumatic tire including a vulcanized rubber of the rubber composition.

The above object can be achieved by the following configurations. Specifically, the present invention relates to a rubber composition (1) containing a diene-based rubber, porous cellulose particles, and a vegetable oil, wherein the vegetable oil is a fatty acid ester triglyceride in which a fatty acid containing at least a saturated fatty acid and an unsaturated fatty acid is ester-bonded to glycerol and has a ratio of the unsaturated fatty acid in the fatty acid of 50 mass % or more.

The rubber composition (1) is preferably a rubber composition (2), wherein the vegetable oil preferably has a ratio of a polyunsaturated fatty acid in the unsaturated fatty acid of 15 mass % or more.

The rubber composition (1) or (2) is preferably a rubber composition (3), wherein the vegetable oil has an iodine value of 100 or more.

Any one of the rubber compositions (1) to (3) is preferably a rubber composition (4), wherein a content of the vegetable oil is 5 to 20 parts by mass when a total amount of the diene-based rubber is taken as 100 parts by mass.

Any one of the rubber compositions (1) to (4) is preferably a rubber composition (5), wherein a content of the porous cellulose particle is 0.5 to 5.0 parts by mass when a total amount of the diene-based rubber is taken as 100 parts by mass.

The present invention also relates to a pneumatic tire (6) including at least a vulcanized rubber of any one of the rubber compositions (1) to (5), particularly to a studless tire (7) including a vulcanized rubber of any one of the rubber compositions (1) to (5) at least in a tread part.

The rubber composition according to the present invention contains at least porous cellulose particles and a vegetable oil having a specific unsaturated fatty acid ratio. More specifically, the rubber composition according to the present invention contains, in a diene-based rubber, porous cellulose particles, and a vegetable oil which is a fatty acid ester triglyceride in which a fatty acid containing at least a saturated fatty acid and an unsaturated fatty acid is ester-bonded to glycerol and has a ratio of the unsaturated fatty acid in the fatty acid of 50 mass % or more. The vulcanized rubber of the rubber composition having such a configuration can achieve grip performance and response performance on an icy road surface improved in a balanced way.

The vulcanized rubber of the rubber composition according to the present invention achieves grip performance and response performance on an icy road surface improved in a balanced way. Therefore, the vulcanized rubber of the rubber composition according to the present invention can be suitably used for pneumatic tires, and is particularly useful as a vulcanized rubber used for tread applications of studless tires.

### DETAILED DESCRIPTION OF THE PREFERRED EMBODIMENTS

The rubber composition according to the present invention contains a diene-based rubber, porous cellulose particle, and a vegetable oil.

Examples of the diene-based rubber include, but are not limited to, natural rubber (NR), isoprene rubber (IR), butadiene rubber (BR) having no modifying group (functional group), styrene-butadiene rubber (SBR), acrylonitrile-butadiene rubber (NBR), chloroprene rubber (CR), styrene-isoprene copolymer rubber, butadiene-isoprene copolymer rubber, and styrene-isoprene-butadiene copolymer rubber. These diene-based rubbers may be used singly or in combination of two or more of them.

As the porous cellulose particle, a porous cellulose particle having a porosity of 75 to 95% can be suitably used. The pores of the porous cellulose particles having such a porosity can effectively absorb and remove water from the water membrane on the icy road surface when the porous cellulose particles are brought into contact with the icy road surface. Furthermore, since the effect of scratching the icy road surface is exhibited by the edge effect of the wall surface of the pores, the pores greatly contribute to the improvement of grip performance and response performance on an icy road surface when used for pneumatic tire applications, particularly for tread applications of studless tires.

The average particle diameter of the porous cellulose particles is not particularly limited, but is preferably 1,000 μm or less, more preferably 100 to 800 μm, and still more preferably 200 to 800 μm from the viewpoint of solving the problems of the present invention.

From the viewpoint of improving the dispersibility in the rubber composition, the porous cellulose particle is preferably a spherical particle having a ratio of major axis/minor axis of 1 to 2, and more preferably a spherical particle having a ratio of major axis/minor axis of 1 to 1.5.

The rubber composition according to the present invention contains a specific vegetable oil, specifically, a vegetable oil which is a fatty acid ester triglyceride in which a fatty acid containing at least a saturated fatty acid and an unsaturated fatty acid is ester-bonded to glycerol and has a ratio of the unsaturated fatty acid in the fatty acid of 50 mass % or more. In the present invention, the vegetable oil is represented by the following formula (1).

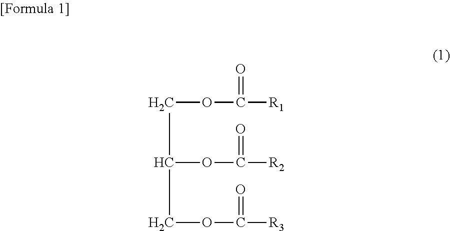

In the above formula (1), R₁, R₂, and R₃ are residues of a fatty acid of either a saturated fatty acid or an unsaturated fatty acid. Examples of the saturated fatty acid include palmitic acid (C16:0) and stearic acid (C18:0). Examples of the unsaturated fatty acid include oleic acid (C18:1), linoleic acid (C18:2), and linolenic acid (C18:3). The rubber composition according to the present invention contains a fatty acid ester triglyceride (vegetable oil) having a ratio of the unsaturated fatty acid in the fatty acid of 50 mass % or more. In order to improve grip performance and response performance on an icy road surface of the vulcanized rubber in a balanced way, it is preferable to use a fatty acid ester triglyceride having a ratio of the unsaturated fatty acid in the fatty acid of 50 mass % or more, and it is more preferable to use a fatty acid ester triglyceride having a ratio of 70 mass % or more.

From the viewpoint of solving the problems, in the rubber composition according to the present invention, a content of the fatty acid ester triglyceride (vegetable oil) is preferably 5 to 30 parts by mass and more preferably 10 to 25 parts by mass when the total amount of the diene-based rubber is taken as 100 parts by mass.

Among fatty acid ester triglycerides (vegetable oils), fatty acid ester triglycerides (vegetable oils) having a high ratio of linoleic acid or linolenic acid as a polyunsaturated fatty acid (hereinafter, also referred to as “PUFA”) having two or more unsaturated bonds are preferable because the wet grip performance, low-temperature performance, and rolling performance of a vulcanized rubber to be finally obtained can be improved in a particularly balanced way. Particularly, in the present invention, from the viewpoint of solving the problems, it is preferable to use a fatty acid ester triglyceride (vegetable oil) having a ratio of the polyunsaturated fatty acid (PUFA) in the unsaturated fatty acid of 15 mass % or more, it is preferable to use a fatty acid ester triglyceride having a ratio of 20 mass % or more, and it is more preferable to use a fatty acid ester triglyceride having a ratio of 70 mass % or more.

In the present invention, rapeseed oil, soybean oil, safflower oil, and sunflower oil can be suitably used as the fatty acid ester triglyceride (vegetable oil). Table 1 shows the fatty acid composition and iodine value of each vegetable oil.

TABLE 1

| | | | Unsaturated fatty acid (%) | | | | | |
|---|---|---|---|---|---|---|---|---|
| | Saturated fatty acid (%) | | MUFA | | PUFA | | | |
| | SAFA | SAFA | Number of | PUFA | Number of | | | |
| | Number of | Number of | car- | Number of | car- | | | |
| | car- | car- | bons:Number | car- | bons:Number | | | |
| | bons:Number | bons:Number | of double | bons:Number | of double | Fatty acid parameter | | |
| | of double | of double | double | of double | double | Unsaturated | | |
| | bonds | bonds | bonds | double bonds | bonds | fatty acid | PUFA ratio | Iodine |
| | 16:0 | 18:0 | 18:1 | 18:2 | 18:3 | ratio in | in | value |
| Type of | Palmitic | Stearic | Oleic | Linoleic | α-Linolenic | total fatty | unsaturated | (g iodine/ |
| vegetable oil | acid | acid | acid | acid | acid | acids | fatty acid | 100 g) |
| Rapeseed oil | 4.1 | 1.7 | 63.5 | 19.3 | 9 | 91.8 | 30.8 | 113 |
| Soybean oil | 10.6 | 4.1 | 23.3 | 53.7 | 7.2 | 84.2 | 72.3 | 128 |
| Safflower oil | 4.9 | 2.1 | 78.3 | 13.3 | 0.3 | 91.9 | 14.8 | 92 |
| Sunflower oil | 4 | 2.7 | 82.7 | 8.5 | 0.2 | 91.4 | 9.5 | 84 |
| Palm oil | 44 | 4.5 | 39.7 | 9.6 | 0.2 | 49.5 | 19.8 | 52 |

As shown in Table 1, rapeseed oil (having a ratio of the polyunsaturated fatty acid (PUFA) in the unsaturated fatty acid of 30.8 mass %) and soybean oil (having a ratio of the polyunsaturated fatty acid (PUFA) in the unsaturated fatty acid of 72.3 mass %) have a high PUFA ratio. Therefore, when the rubber composition according to the present invention contains rapeseed oil or soybean oil as fatty acid ester triglyceride (vegetable oil), the grip performance and response performance on an icy road surface of the vulcanized rubber to be finally obtained can be improved in a particularly balanced way, which is preferable. Although the reason why such an effect can be obtained is not clear, it is considered that the dispersibility of the porous cellulose particles is improved by the presence of rapeseed oil or soybean oil in the diene-based rubber, and as a result, the above-described effects of the porous cellulose particles (water absorption and water removal effects of a water membrane on a road surface, edge effects of wall surfaces of pores, and the like) are further enhanced.

Among fatty acid ester triglycerides (vegetable oils), in particular, when a fatty acid ester triglyceride having an iodine value of 100 or more is used, the amount of double bonds in the fatty acid ester triglyceride (vegetable oil) is increased, and therefore the grip performance and response performance on an icy road surface of the vulcanized rubber to be finally obtained can be improved in a particularly balanced way, which is preferable.

When the rubber composition according to the present invention contains silica as a filler, the reinforcing effect of silica is more effectively exhibited by a dispersion effect of silica by a specific vegetable oil. As a result, the vulcanized rubber to be finally obtained is preferable because the grip performance and response performance on an icy road surface can be improved particularly in a balanced way. Examples of the silica to be used include silicas usually used for rubber reinforcement, such as wet silica, dry silica, sol-gel silica, and surface-treated silica. Among these, wet silica is preferred. From the viewpoint of solving the problems, in the rubber composition according to the present invention, a content of silica is preferably 20 to 100 parts by mass and more preferably 30 to 80 parts by mass when the total amount of the diene-based rubber is taken as 100 parts by mass.

When silica is contained as a filler, a silane coupling agent is also preferably contained together. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e.g., “Si69” manufactured by Evonik Japan Co., Ltd.), bis(3-triethoxysilylpropyl)disulfide (e.g., “Si75” manufactured by Evonik Japan Co., Ltd.), bis(2-triethoxysilylethyl)tetrasulfide, bis(4-triethoxysilylbutyl)disulfide, bis(3-trimethoxysilylpropyl) tetrasulfide, and bis(2-trimethoxysilylethyl)disulfide; mercaptosilanes such as [symbol] -mercaptopropyltrimethoxysilane, [symbol] -mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane. The content of the silane coupling agent is preferably 5 to 20 mass % when the total amount of silica is taken as 100 mass %.

The rubber composition according to the present invention contains a diene-based rubber, porous cellulose particles, and a vegetable oil, and preferably further contains silica and a silane coupling agent. The rubber composition according to the present invention may contain, in addition to the above, carbon black, a vulcanizing agent, a vulcanization accelerator, an antiaging agent, stearic acid, a softener such as wax or oil, a processing aid, and others.

The rubber composition according to the present invention may contain carbon black as a filler. Examples of the carbon black that can be used include: carbon blacks usually used in the rubber industry, such as SAF, ISAF, HAF, FEF, and GPF; and conductive carbon blacks such as acetylene black and ketjen black. The content of the carbon black in the rubber composition for pneumatic tires according to the present invention is preferably 1 to 30 parts by mass when the total amount of the diene-based rubber is taken as 100 parts by mass.

As the vulcanizing agent, sulfur can suitably be used. The sulfur may be ordinary sulfur for rubber, and sulfur such as powdered sulfur, precipitated sulfur, insoluble sulfur, or highly dispersible sulfur can be used. The content of the vulcanizing agent in the rubber composition for tires according to the present invention is preferably 0.1 to 10 parts by mass when the total amount of the diene-based rubber is taken as 100 parts by mass.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

The rubber composition according to the present invention is obtained by kneading a diene-based rubber, porous cellulose particles, and a vegetable oil, preferably, in addition to silica and a silane coupling agent, carbon black, a vulcanizing agent, a vulcanization accelerator, zinc oxide, an antiaging agent, stearic acid, a softener such as wax, a processing aid, and others with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a vulcanizing agent and a vulcanization accelerator are previously kneaded to prepare a master batch, the remaining components are added to the master batch, and the resultant is further kneaded, a method in which components are added in any order and kneaded, and a method in which all the components are added at the same time and kneaded.

The vulcanized rubber of the rubber composition according to the present invention achieves grip performance and response performance on an icy road surface improved in a particularly balanced way. Therefore, the vulcanized rubber of the rubber composition according to the present invention can be suitably used for pneumatic tires, and is particularly useful as a vulcanized rubber used for tread applications of studless tires.

### EXAMPLES

Hereinbelow, the present invention will more specifically be described with reference to examples.

### (Preparation of Rubber Compositions for Tires)

A rubber composition for tires of each of Examples 1 to 6 and Comparative Examples 1 to 5 was prepared by blending compounding agents with 100 parts by mass of a rubber component in accordance with a formulation shown in any one of Tables 2 to 3 and kneading the resultant using an ordinary Banbury mixer. The compounding agents shown in Tables 2 to 3 are as follows.

### (Diene-Based Rubber)

Natural rubber: RSS #3
Butadiene rubber: trade name “BR730”, manufactured by ENEOS Materials Corporation

### (Porous Cellulose Particle)

Porous cellulose particle: trade name “Viscopearl Mini”, manufactured by Rengo Co., Ltd.

### (Vegetable Oil)

Rapeseed oil: trade name “refined rapeseed oil”, manufactured by Nisshin OilliO Co., Ltd.
Soybean oil: trade name “soy salad oil (S)”, manufactured by Nisshin OilliO Co., Ltd.
Palm oil: trade name “refined palm oil (S)”, manufactured by Nisshin OilliO Co., Ltd.
Safflower oil: trade name “safflower oil (high oleic)”, manufactured by Nisshin OilliO Co., Ltd.
Sunflower oil: trade name “sunflower oil (S)”, manufactured by Nisshin OilliO Co., Ltd.

### (Filler)

Carbon black: trade name “N234 Seast 7HM”, manufactured by TOKAI CARBON CO., LTD.
Silica: trade name “Nipsil AQ”, manufactured by Tosoh Corporation

### (Other Compounding Agents)

Silane coupling agent: trade name “Si-75”, manufactured by Evonik Industries AG
Zinc oxide: trade name “Zinc oxide grade 2”, manufactured by MITSUI MINING & SMELTING CO., LTD.
Stearic acid: trade name “LUNAC S-20”, manufactured by Kao Corporation
Wax: trade name “OZOACE 0355”, manufactured by NIPPON SEIRO CO., LTD.
Antiaging agent: trade name “NOCRAC 6C”, manufactured by OUCHI SHINKO CHEMICAL INDUSTRIAL CO., LTD.
Terpene resin: trade name “SYLVATRAXX 4150”, manufactured by Kraton Corporation
Oil: trade name “PROCESS P200”, manufactured by ENEOS Corporation
Liquid rubber: trade name “LBR305”, manufactured by Kuraray Co., Ltd.
Vulcanization accelerator 1: trade name “NOCCELER D”, manufactured by OUCHI SHINKO CHEMICAL INDUSTRIAL CO., LTD.
Vulcanization accelerator 2: trade name “SOXINOL CZ”, manufactured by SUMITOMO CHEMICAL COMPANY, LIMITED
Sulfur: trade name “Powder Sulfur”, manufactured by Tsurumi Chemical Industry Co., ltd.

Unvulcanized samples of the rubber compositions of Examples 1 to 6 and Comparative Examples 1 to 5 obtained above were prepared, and then the on-ice braking performance and response performance on an icy road surface were evaluated under the following conditions.

### (On-Ice Braking Performance on Icy Road Surface)

A studless tire obtained by applying the obtained rubber composition to a tread was mounted on a 2,000 cc 4WD car, and the ABS was operated at a speed of 40 km/h at an air temperature of −2° C. to −6° C. to measure a braking distance on ice (average value of n=10). The reciprocal of the measured braking distance was expressed as an index when the value in Comparative Example 1 is 100. A larger index indicates that the braking distance is shorter and the on-ice braking performance is better.

### (Response Performance on Icy Road Surface)

A driver in charge of sensory test traveled on a test course on an icy road surface at an air temperature of −2° C. to −6° C. while paying attention to steering responsiveness, running stability (wandering), and the like, and sensory evaluation (evaluation of feeling performance) of response performance was performed. The results are shown in the table, setting an excellent sample as +2, a slightly excellent sample as +1, an equivalent sample as ±0, a slightly poor sample as −1, and a poor sample as −2, as compared with Comparative Example 1 as a control.

TABLE 2

| | | | | | |
|---|---|---|---|---|---|
| Comparative | | | Comparative | | |
| Example 1 | Example 1 | Example 2 | Example 2 | Example 3 | Example 4 |

(Formulation)

| Diene-based | Natural rubber | 50 | 50 | 50 | 50 | 50 | 50 |
|---|---|---|---|---|---|---|---|
| rubber | Butadiene rubber | 50 | 50 | 50 | 50 | 50 | 50 |
| Porous cellulose particle | | 2 | 2 | 2 | 2 | 2 | 2 |
| Vegetable oil | Rapeseed oil | | 20 | | | | |
| | Soybean oil | | | 20 | | | |
| | Palm oil | | | | 20 | | |
| | Safflower oil | | | | | 20 | |
| | Sunflower oil | | | | | | 20 |
| Filler | Carbon black | 9 | 9 | 9 | 9 | 9 | 9 |
| | Silica | 50 | 50 | 50 | 50 | 50 | 50 |
| Other | Silane coupling agent | 3.5 | 3.5 | 3.5 | 3.5 | 3.5 | 3.5 |
| compounding | Zinc oxide | 2 | 2 | 2 | 2 | 2 | 2 |
| agents | Stearic acid | 2 | 2 | 2 | 2 | 2 | 2 |
| | Wax | 1.5 | 1.5 | 1.5 | 1.5 | 1.5 | 1.5 |
| | Antiaging agent | 4 | 4 | 4 | 4 | 4 | 4 |
| | Terpene resin | 10 | 10 | 10 | 10 | 10 | 10 |
| | Oil | 20 | | | | | |
| | Liquid rubber | | | | | | |
| | Vulcanization | 0.9 | 0.9 | 0.9 | 0.9 | 0.9 | 0.9 |
| | accelerator 1 | | | | | | |
| | Vulcanization | 1.1 | 1.1 | 1.1 | 1.1 | 1.1 | 1.1 |
| | accelerator 2 | | | | | | |
| | Sulfur | 1.4 | 1.4 | 1.4 | 1.4 | 1.4 | 1.4 |

(Evaluation)

| | | | | | | | |
|---|---|---|---|---|---|---|---|
| Vulcanized | On-ice braking | 100 | 115 | 114 | 91 | 103 | 102 |
| rubber | performance | | | | | | |
| | Response performance | 0 | +2 | +1 | 0 | +1 | +1 |

Rapeseed oil has a ratio of the unsaturated fatty acid in the fatty acid of 91.8 mass % and a ratio of the polyunsaturated fatty acid in the unsaturated fatty acid of as high as 30.8 mass %. Also, soybean oil has a ratio of the unsaturated fatty acid in the fatty acid of 84.2 mass % and a ratio of the polyunsaturated fatty acid in the unsaturated fatty acid of as high as 72.3 mass %. As can be seen from the results shown in Table 2, in the vulcanized rubber of the rubber composition according to Example 1 using rapeseed oil and the vulcanized rubber of the rubber composition according to Example 2 using soybean oil, the on-ice braking performance and response performance on an icy road surface are improved in a balanced way. Also, it can be seen that also in the vulcanized rubber of the rubber composition according to Example 3 using safflower oil and the vulcanized rubber of the rubber composition according to Example 4 using sunflower oil, the on-ice braking performance and response performance on an icy road surface are improved in a balanced way. However, since safflower oil and sunflower oil both have a low ratio of the polyunsaturated fatty acid in the unsaturated fatty acid, it can be seen that safflower oil and sunflower oil are less effective than rapeseed oil and soybean oil. On the other hand, it can be seen that the vulcanized rubber of the rubber composition according to Comparative Example 3 using palm oil having a ratio of the unsaturated fatty acid in the fatty acid of as low as 49.8 mass % is particularly deteriorated in on-ice braking performance on an icy road surface.

TABLE 3

| | | | | | |
|---|---|---|---|---|---|
| Comparative | | | Comparative | Comparative | Comparative |
| Example 1 | Example 5 | Example 6 | Example 3 | Example 4 | Example 5 |

(Formulation)

| Diene-based | Natural rubber | 50 | 50 | 50 | 50 | 50 | 50 |
|---|---|---|---|---|---|---|---|
| rubber | Butadiene rubber | 50 | 50 | 50 | 50 | 50 | 50 |
| Porous cellulose particle | | 2 | 2 | 2 | 2 | 2 | |
| Vegetable | Rapeseed oil | | 10 | 30 | | | 20 |
| oil | Soybean oil | | | | | | |
| | Palm oil | | | | | | |
| | Safflower oil | | | | | | |
| | Sunflower oil | | | | | | |
| Filler | Carbon black | 9 | 9 | 9 | 9 | 9 | 9 |
| | Silica | 50 | 50 | 50 | 50 | 50 | 50 |
| Other | Silane coupling agent | 3.5 | 3.5 | 3.5 | 3.5 | 3.5 | 3.5 |
| compounding | Zinc oxide | 2 | 2 | 2 | 2 | 2 | 2 |
| agents | Stearic acid | 2 | 2 | 2 | 2 | 2 | 2 |
| | Wax | 1.5 | 1.5 | 1.5 | 1.5 | 1.5 | 1.5 |
| | Antiaging agent | 4 | 4 | 4 | 4 | 4 | 4 |
| | Terpene resin | 10 | 10 | 10 | 10 | 10 | 10 |
| | oil | 20 | 10 | | 10 | | |
| | Liquid rubber | | | | 10 | 20 | |
| | Vulcanization | 0.9 | 0.9 | 0.9 | 0.9 | 0.9 | 0.9 |
| | accelerator 1 | | | | | | |
| | Vulcanization | 1.1 | 1.1 | 1.1 | 1.1 | 1.1 | 1.1 |
| | accelerator 2 | | | | | | |
| | Sulfur | 1.4 | 1.4 | 1.4 | 1.4 | 1.4 | 1.4 |

(Evaluation)

| | | | | | | | |
|---|---|---|---|---|---|---|---|
| Vulcanized | On-ice braking | 100 | 109 | 114 | 105 | 110 | 105 |
| rubber | performance | | | | | | |
| | Response performance | 0 | +2 | +1 | 0 | −1 | 0 |

As can be seen from the results shown in Table 3, also in the vulcanized rubbers of the rubber compositions according to Examples 5 to 6 in which the content of rapeseed oil has been variously changed, the on-ice braking performance and response performance on an icy road surface are improved in a balanced way. On the other hand, in the vulcanized rubbers of the rubber compositions according to Comparative Examples 3 and 4 using the liquid rubber, it can be seen that the response performance on an icy road surface is particularly deteriorated, and thus both the on-ice braking performance and the response performance on an icy road surface cannot be achieved.

What is claimed is:

1. A rubber composition comprising a diene-based rubber, porous cellulose particles, and a vegetable oil,
wherein the vegetable oil is a fatty acid ester triglyceride in which a fatty acid containing at least a saturated fatty acid and an unsaturated fatty acid is ester-bonded to glycerol and has a ratio of the unsaturated fatty acid in the fatty acid of 50 mass % or more.

2. The rubber composition according to claim 1, wherein the vegetable oil has a ratio of a polyunsaturated fatty acid in the unsaturated fatty acid of 15 mass % or more.

3. The rubber composition according to claim 1, wherein the vegetable oil has an iodine value of 100 or more.

4. The rubber composition according to claim 1, wherein a content of the vegetable oil is 5 to 20 parts by mass when a total amount of the diene-based rubber is taken as 100 parts by mass.

5. The rubber composition according to claim 1, wherein a content of the porous cellulose particle is 0.5 to 5.0 parts by mass when a total amount of the diene-based rubber is taken as 100 parts by mass.

6. A pneumatic tire comprising a vulcanized rubber of the rubber composition according to claim 1.

7. A studless tire comprising a tread part containing a vulcanized rubber of the rubber composition according to claim 1.
